(19) United States
(12) Patent Application Publication
(10) Pub. No.: US 2014/0241272 A1
(43) Pub. Date: Aug. 28, 2014

(54) INTERFACE BETWEEN LOW POWER NODE AND MACRO CELL TO ENABLE DECOUPLED UPLINK AND DOWNLINK COMMUNICATION

(71) Applicant: QUALCOMM Incorporated, San Diego, CA (US)

(72) Inventors: Miguel GRIOT, La Jolla, CA (US); Hao XU, San Diego, CA (US); Tingfang JI, San Diego, CA (US); Gavin Bernard HORN, La Jolla, CA (US)

(73) Assignee: QUALCOMM INCORPORATED, San Diego, CA (US)

(21) Appl. No.: 14/188,057

(22) Filed: Feb. 24, 2014

Related U.S. Application Data
(60) Provisional application No. 61/769,011, filed on Feb. 25, 2013.

(51) Int. Cl. H04W 74/08

(52) U.S. Cl. CPC H04W 74/0833
USPC 370/329

(57) ABSTRACT

Certain aspects provide a method for wireless communications with low powered, possible low cost devices, such as machine-type communications (MTC) devices. A method for wireless communications by a wireless node is provided. The method generally includes receiving, from a base station of a cell, signaling indicating a random access channel (RACH) configuration for a wireless device, detecting, based on the RACH configuration, the wireless device performing a RACH procedure, reporting the RACH detection to the base station of the cell, receiving signaling indicating the wireless node has been selected to serve the wireless device for uplink communications with the base station of the cell, receiving uplink data transmitted from the wireless device, and forwarding the uplink data to the base station of the cell.

### CLAIM OF PRIORITY UNDER 35 U.S.C. §119

This application claims benefit of U.S. Provisional Patent Application Ser. No. 61/769,011, filed Feb. 25, 2013, which is herein incorporated by reference in its entirety.

### BACKGROUND

I. Field

Certain aspects of the disclosure generally relate to wireless communications and, more particularly, to techniques for enabling decoupled uplink (UL) and downlink (DL) communications through the interface between low power node (LPN) and macro cell.

Wireless communication networks are widely deployed to provide various communication services such as voice, video, packet data, messaging, and broadcast services. These wireless communication networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of eNodeBs that can support communication for a number of user equipments (UEs). A UE may communicate with an eNodeB via the downlink and uplink. The downlink (or forward link) refers to the communication link from the eNodeB to the UE, and the uplink (or reverse link) refers to the communication link from the UE to the eNodeB.

In certain wireless communication systems, in addition to higher power “macro” eNodeBs, a number of relatively small, lower power nodes (e.g., “pico” eNodeBs or relays), may be deployed for capacity enhancements, for example to support machine type communications (MTC) devices. Such devices are typically low cost, low power, and are often deployed in difficult to reach locations, such as a basement. While the macro eNodeBs may have sufficient coverage to reach most MTC devices on the downlink, uplink communications for a given device may be more efficiently provided via a lower power node in close proximity to the devices (e.g., requiring lower uplink transmission power).

While allowing MTC devices to operate across systems with different types of base stations may help enhance service coverage, allowing different types of base stations to serve a same device for uplink and downlink communications present a challenge, for example, due to a need to identify and select low power nodes that are in proximity to a device.

### SUMMARY

Certain aspects of the disclosure generally relate to wireless communications and, more particularly, to techniques for enabling decoupled uplink (UL) and downlink (DL) communications through the interface between low power node (LPN) and macro cell.

Certain aspects of the present disclosure provide a method for wireless communications by a wireless node, corresponding apparatuses and computer program products. The method generally includes receiving, from a base station of a cell, signaling indicating a random access channel (RACH) configuration for a wireless device, detecting, based on the RACH configuration, the wireless device performing a RACH procedure, reporting the RACH detection to the base station of the cell, receiving signaling indicating the wireless node has been selected to serve the wireless device for uplink communications with the base station of the cell, receiving uplink data transmitted from the wireless device, and forwarding the uplink data to the base station of the cell.

The apparatus generally includes means for receiving, from a base station of a cell, signaling indicating a random access channel (RACH) configuration for a wireless device, means for detecting, based on the RACH configuration, the wireless device performing a RACH procedure, means for reporting the RACH detection to the base station of the cell, means for receiving signaling indicating the wireless node has been selected to serve the wireless device for uplink communications with the base station of the cell, means for receiving uplink data transmitted from the wireless device, and means for forwarding the uplink data to the base station of the cell.

The apparatus generally includes at least one processor configured to receive, from a base station of a cell, signaling indicating a random access channel (RACH) configuration for a wireless device, detect, based on the RACH configuration, the wireless device performing a RACH procedure, report the RACH detection to the base station of the cell, receive signaling indicating the wireless node has been selected to serve the wireless device for uplink communications with the base station of the cell, receive uplink data transmitted from the wireless device, and forward the uplink data to the base station of the cell.

The computer program product generally includes a computer readable-medium having instructions stored thereon for receiving, from a base station of a cell, signaling indicating a random access channel (RACH) configuration for a wireless device, detecting, based on the RACH configuration, the wireless device performing a RACH procedure, reporting the RACH detection to the base station of the cell, receiving signaling indicating the wireless node has been selected to serve the wireless device for uplink communications with the base station of the cell, receiving uplink data transmitted from the wireless device, and forwarding the uplink data to the base station of the cell.

Certain aspects of the present disclosure provide methods for wireless communications by a wireless node, corresponding apparatuses and computer program products. The method generally includes forwarding, to one or more base stations, signaling indicating a random access channel (RACH) configuration for a wireless device, receiving one or more reports, from the one or more base stations, of a RACH detection based on the RACH configuration, selecting a base station of the one or more base stations to serve the wireless device for uplink communications based on the one or more reports, signaling an indication of the selected base station to the one or more base stations, and receiving uplink data, from the selected base station forwarded from the wireless device.

The apparatus generally includes means for forwarding, to one or more base stations, signaling indicating a random access channel (RACH) configuration for a wireless device, means for receiving one or more reports, from the one or more base stations, of a RACH detection based on the RACH configuration, means for selecting a base station of the one or more base stations to serve the wireless device for uplink communications based on the one or more reports, means for signaling an indication of the selected base station to the one or more base stations, and means for receiving uplink data, from the selected base station forwarded from the wireless device.

Various aspects and features of the disclosure are described in further detail below.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a wireless communications system, in accordance with an aspect of the present disclosure.

FIG. 2 is a block diagram conceptually illustrating an example of a downlink frame structure, in accordance with an aspect of the present disclosure.

FIG. 3 is a block diagram conceptually illustrating an exemplary evolved NodeB (eNB) and an exemplary user equipment (UE), in accordance with an aspect of the present disclosure.

FIG. 4 is a block diagram conceptually illustrating an example of a heterogeneous wireless communications system, in accordance with an aspect of the present disclosure.

FIG. 5 illustrates an example call flow diagram for an exchange of transmissions between the entities of FIG. 4.

FIG. 6 illustrates example architecture and call flow for decoupled downlink/uplink (DL/UL) operation, in accordance with certain aspects of the present disclosure.

FIG. 7 illustrates example user plane protocol stack, in accordance with certain aspects of the present disclosure.

FIG. 8 illustrates example call flow for an X4 interface setup procedure, in accordance with certain aspects of the present disclosure.

FIG. 9 illustrates an example call flow for UE UL forwarding deactivation, in accordance with certain aspects of the present disclosure.

FIG. 10 illustrates an example call flow for decoupled DL/UL operation, in accordance with certain aspects of the present disclosure.

FIG. 11 illustrates example operations for wireless communications, in accordance with certain aspects of the present disclosure.

FIG. 12 illustrates example operations for wireless communications, in accordance with certain aspects of the present disclosure.

### DETAILED DESCRIPTION

As noted above, in some cases, relatively dense deployment of low power nodes (LPNs) within a macro cell coverage area may be used to provide coverage enhancement, for example, for machine type communication (MTC) devices that may be low power and low cost or other devices that may have a high delay tolerance. Examples of such low power nodes (LPNs) may include pico base station, relays, or remote radio heads (RRHs). Such cell densification may reduce path loss to the closest LPN cell and may potentially enhance coverage while reducing energy consumption by reducing uplink transmission power.

Decoupling downlink and uplink communications may allow optimal devices to be selected independently for uplink and downlink communications. For example, downlink (DL) coverage for devices by high power nodes (e.g., a Macro cell eNodeB) may be allowed, while allowing uplink (UL) coverage by the cells with the smallest path loss (e.g., via a low power node closest to a UE). A device may have different associations for DL and UL operations.

Certain factors may help enable decoupling of DL and UL communications for MTC devices, as presented herein. For example, MTC devices may be relatively delay tolerant, with relatively small packet sizes and low requirements regarding spectral efficiency (e.g., many such devices may only need to transmit a relatively small amount of data relatively infrequently). Such delay tolerance may allow sufficient time (e.g., on the order of seconds) for the information exchange between a Macro eNodeB and a low power node (LPN), as well as for a delayed response between RACH messages. The high delay tolerance may allow for a flexible HARQ turnaround requirement (e.g., on the order of milliseconds) for communication and data transmissions without channel state feedback (e.g., CQI).

Techniques are provided herein for an interface between a LPN and a Macro cell, in order to enable decoupled UL/DL operations. According to certain aspects, a LPN detects a random access channel (RACH) transmitted by a MTC device and reports the detected RACH to a Macro base station (BS) along with scheduling and configuration information. The BS can then select the LPN to serve the UL for the device. The device receives DL signaling only from the BS and is unaware of the forwarding LPN serving on the uplink.

While examples are describes with reference to MTC devices, the techniques presented herein may be applied to any type of delay tolerant devices and, more generally, to any type of device.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

A base station (“BS”) may comprise, be implemented as, or known as NodeB, Radio Network Controller (“RNC”), Evolved NodeB (eNodeB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A user equipment (UE) may comprise, be implemented as, or known as an access terminal, a subscriber station, a subscriber unit, a remote station, a remote terminal, a mobile station, a user agent, a user device, user equipment, a user station, or some other terminology. In some implementations, mobile station may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Communication System

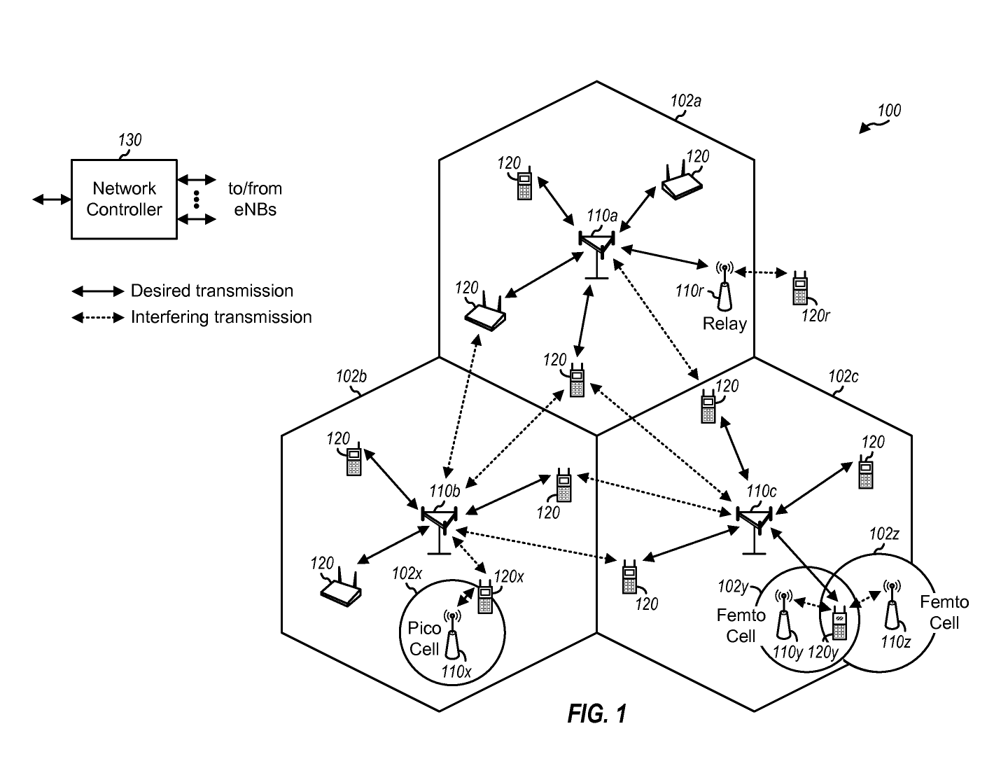

FIG. 1 is a block diagram conceptually illustrating an example of a telecommunications network system 100, in accordance with an aspect of the present disclosure. For example, the telecommunications network system 100 may be, for example, an LTE network and may include a number of evolved NodeBs (eNodeBs) 110 and user equipment (UEs) 120 and other network entities. An eNodeB 110 may be a station that communicates with the UEs 120 and may also be referred to as a base station, an access point, etc. A NodeB is another example of a station that communicates with the UEs 120.

Each eNodeB 110 may provide communication coverage for a particular geographic area. In 3GPP, the term “cell” can refer to a coverage area of an eNodeB 110 and/or an eNodeB subsystem serving the coverage area, depending on the context in which the term is used.

An eNodeB 110 may provide communication coverage for a macro cell, a pico cell, a femto cell, and/or other types of cell. A macro cell may cover a relatively large geographic area (e.g., several kilometers in radius) and may allow unrestricted access by UEs 120 with service subscription. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 may be subscribed to a Closed Subscriber Group (CSG), UEs 120 for users in the home, etc.). An eNodeB 110 for a macro cell may be referred to as a macro eNodeB. An eNodeB 110 for a pico cell may be referred to as a pico eNodeB. An eNodeB 110 for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB 110 may provide communication coverage for one or more (e.g., three) cells.

The telecommunications network system 100 may include one or more relay stations 110r and 120r, that may also be referred to as a relay eNodeB, a relay, etc. The relay station 110r may be a station that receives a transmission of data and/or other information from an upstream station (e.g., an eNodeB 110 or a UE 120) and sends the received transmission of the data and/or other information to a downstream station (e.g., a UE 120 or an eNodeB 110). The relay station 120r may be a UE that relays transmissions for other UEs (not shown). In the example shown in FIG. 1, the relay station 110r may communicate with the eNodeB 110a and the UE 120r in order to facilitate communication between the eNodeB 110a and the UE 120r.

The telecommunications network system 100 may be a heterogeneous network that includes eNodeBs 110 of different types, e.g., macro eNodeBs 110a-c, pico eNodeBs 110x, femto eNodeBs 110y-z, relays 110r, etc. These different types of eNodeBs 110 may have different transmit power levels, different coverage areas, and different impact on interference in the telecommunications network system 100. For example, macro eNodeBs 110a-c may have a high transmit power level (e.g., 20 Watts) whereas pico eNodeBs 110x, femto eNodeBs 110y-z and relays 110r may have a lower transmit power level (e.g., 1 Watt).

As will be described in greater detail below, aspects of the present disclosure allow for decoupled uplink and downlink service of devices, such as UEs 120, by different types of base stations with different transmit power levels, for example, with macro eNodeBs providing downlink service and lower power nodes, such as femto eNodeBs 110y-z and/or relays 110r/120r, providing uplink service.

The telecommunications network system 100 may support synchronous or asynchronous operation. For synchronous operation, the eNodeBs 110 may have similar frame timing, and transmissions from different eNodeBs 110 and may be approximately aligned in time. For asynchronous operation, the eNodeBs 110 may have different frame timing, and transmissions from different eNodeBs 110 and may not be aligned in time. The techniques described herein may be used for both synchronous and asynchronous operation.

A network controller 130 may be coupled to a set of eNodeBs 110 and provide coordination and control for these eNodeBs 110. The network controller 130 may communicate with the eNodeBs 110 via a backhaul (not shown). The eNodeBs 110 may also communicate with one another, e.g., directly or indirectly via wireless (over the air “OTA”) or wire line backhaul (e.g., X2 interface, not shown).

The UEs 120 (e.g., 120x, 120y, etc.) may be dispersed throughout the telecommunications network system 100, and each UE 120 may be stationary or mobile. A UE 120 may be able to communicate with macro eNodeBs 110a-c, pico eNodeBs 110x, femto eNodeBs 110y-z, relays 110r, etc. For example, in FIG. 1, a solid line with double arrows may indicate desired transmissions between a UE 120 and a serving eNodeB 110, which is an eNodeB 110 designated to serve the UE 120 on the downlink and/or uplink. A dashed line with double arrows may indicate interfering transmissions between a UE 120 and an eNodeB 110.

LTE may utilize orthogonal frequency division multiplexing (OFDM) on the downlink and single-carrier frequency division multiplexing (SC-FDM) on the uplink. OFDM and SC-FDM may partition the system bandwidth into multiple (K) orthogonal subcarriers, which are also commonly referred to as tones, bins, etc. Each subcarrier may be modulated with data. In general, modulation symbols may be sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal Fast Fourier Transform (FFT) size may be equal to 128, 256, 512, 1024 or 2048 for system bandwidth of 1.25, 2.5, 5, 10 or 20 megahertz (MHz), respectively. The system bandwidth may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively

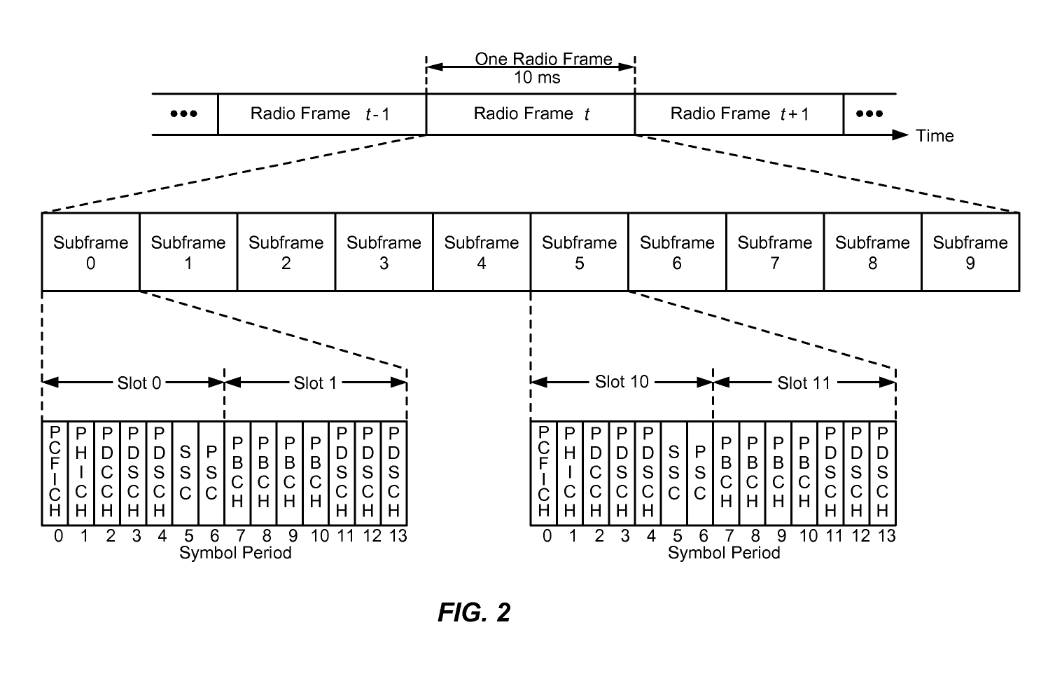

FIG. 2 is a block diagram conceptually illustrating an example of a downlink frame structure, in accordance with an aspect of the present disclosure. The transmission timeline for the downlink may be partitioned into units of radio frames. Each radio frame may have a predetermined duration (e.g., 10 milliseconds (ms)) and may be partitioned into 10 sub-frames with indices of 0 through 9. Each sub-frame may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix (not shown). The 2L symbol periods in each sub-frame may be assigned indices of 0 through 2L−1. The available time frequency resources may be partitioned into resource blocks. Each resource block may cover N subcarriers (e.g., 12 subcarriers) in one slot.

In LTE for example, an eNodeB may send a primary synchronization signal (PSS) and a secondary synchronization signal (SSS) for each cell in the coverage area of the eNodeB. The primary synchronization signal (PSS) and secondary synchronization signal (SSS) may be sent in symbol periods 6 and 5, respectively, in each of sub-frames 0 and 5 of each radio frame with the normal cyclic prefix, as shown in FIG. 2. The synchronization signals may be used by UEs for cell detection and acquisition. The eNodeB may send system information in a Physical Broadcast Channel (PBCH) in symbol periods 0 to 3 of slot 1 of sub-frame 0.

The eNodeB may send information in a Physical Control Format Indicator Channel (PCFICH) in only a portion of the first symbol period of each sub-frame, although depicted in the entire first symbol period in FIG. 2. The PCFICH may convey the number of symbol periods (M) used for control channels, where M may be equal to 1, 2 or 3 and may change from sub-frame to sub-frame. M may also be equal to 4 for a small system bandwidth, e.g., with less than 10 resource blocks. In the example shown in FIG. 2, M=3. The eNodeB may send information in a Physical HARQ Indicator Channel (PHICH) and a Physical Downlink Control Channel (PDCCH) in the first M symbol periods of each sub-frame (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it may be understood that the PDCCH and PHICH are also included in the first symbol period. Similarly, the PHICH and PDCCH are also both in the second and third symbol periods, although not shown that way in FIG. 2. The eNodeB may send information in a Physical Downlink Shared Channel (PDSCH) in the remaining symbol periods of each sub-frame. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH around the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs in the coverage area. The eNodeB may send the PDCCH in a unicast manner to specific UEs in the coverage area. The eNodeB may also send the PDSCH in a unicast manner to specific UEs in the coverage area.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage areas of multiple eNodeBs (or other type base stations). One of these eNodeBs may be selected to serve the UE. The serving eNodeB may be selected based on various criteria such as received power, path loss, signal-to-noise ratio (SNR), etc.

Further, aspects of the present disclosure allow for multiple base stations to be selected based on such criteria, allowing for decoupled uplink and downlink service of devices. For example, a macro eNodeB may be selected to provide downlink service to a UE, based on received power of downlink reference signals, while a lower power node may be selected to provide uplink service to the same UE, based on path loss (e.g., determined based uplink transmissions from the UE as measured and reported by the lower power node).

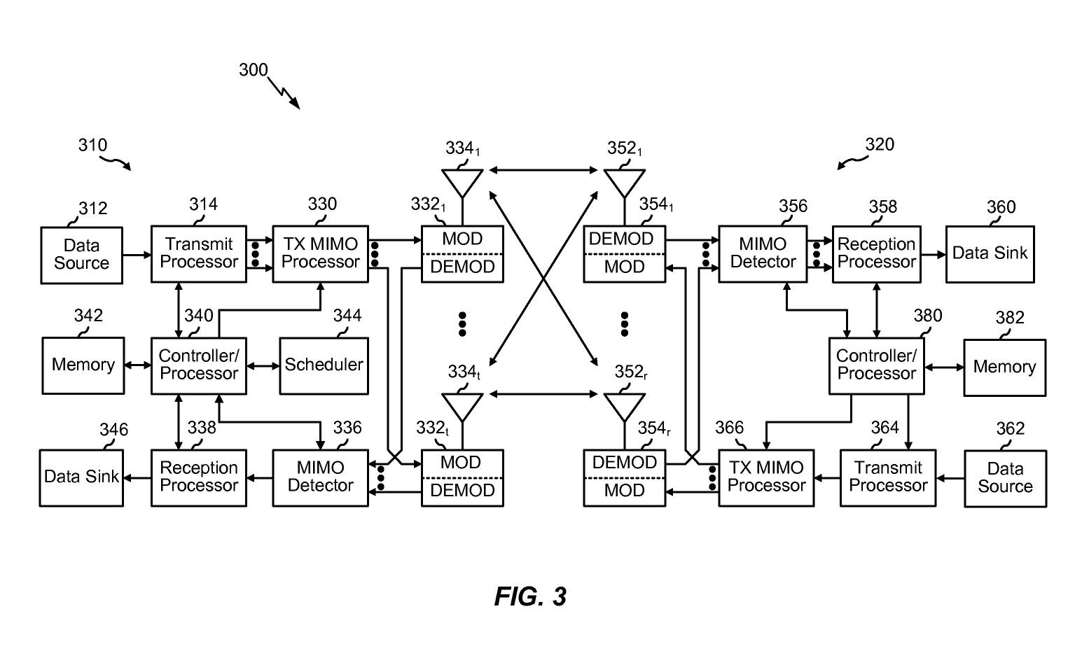

FIG. 3 is a block diagram conceptually illustrating an exemplary eNodeB 310 and an exemplary UE 320 configured in accordance with an aspect of the present disclosure. For example, the UE 315 may be an example of the UE 120 shown in FIG. 1 and capable of operating in accordance with aspects of the present disclosure.

The base station 310 may be equipped with antennas 3341-t, and the UE 320 may be equipped with antennas 3521-r, wherein t and r are integers greater than or equal to one. At the base station 310, a base station transmit processor 314 may receive data from a base station data source 312 and control information from a base station controller/processor 340. The control information may be carried on the PBCH, PCFICH, PHICH, PDCCH, etc. The data may be carried on the PDSCH, etc. The base station transmit processor 314 may process (e.g., encode and symbol map) the data and control information to obtain data symbols and control symbols, respectively. The base station transmit processor 314 may also generate reference symbols, e.g., for the PSS, SSS, and cell-specific reference signal (RS). A base station transmit (TX) multiple-input multiple-output (MIMO) processor 330 may perform spatial processing (e.g., precoding) on the data symbols, the control symbols, and/or the reference symbols, if applicable, and may provide output symbol streams to the base station modulators/demodulators (MODs/DEMODs) 3321-t. Each base station modulator/demodulator 332 may process a respective output symbol stream (e.g., for OFDM, etc.) to obtain an output sample stream. Each base station modulator/demodulator 332 may further process (e.g., convert to analog, amplify, filter, and upconvert) the output sample stream to obtain a downlink signal. Downlink signals from modulators/demodulators 3321-t may be transmitted via the antennas 3341-t, respectively.

At the UE 315, the UE antennas 3521-r may receive the downlink signals from the base station 310 and may provide received signals to the UE modulators/demodulators (MODs/DEMODs) 3541-r, respectively. Each UE modulator/demodulator 354 may condition (e.g., filter, amplify, downconvert, and digitize) a respective received signal to obtain input samples. Each UE modulator/demodulator 354 may further process the input samples (e.g., for OFDM, etc.) to obtain received symbols. A UE MIMO detector 356 may obtain received symbols from all the UE modulators/demodulators 3541-r, and perform MIMO detection on the received symbols if applicable, and provide detected symbols. A UE reception processor 358 may process (e.g., demodulate, deinterleave, and decode) the detected symbols, provide decoded data for the UE 320 to a UE data sink 360, and provide decoded control information to a UE controller/processor 380.

On the uplink, at the UE 315, a UE transmit processor 364 may receive and process data (e.g., for the PUSCH) from a UE data source 362 and control information (e.g., for the PUCCH) from the UE controller/processor 380. The UE transmit processor 364 may also generate reference symbols for a reference signal. The symbols from the UE transmit processor 364 may be precoded by a UE TX MIMO processor 366 if applicable, further processed by the UE modulator/demodulators 3541-r (e.g., for SC-FDM, etc.), and transmitted to the base station 310. At the base station 310, the uplink signals from the UE 315 may be received by the base station antennas 334, processed by the base station modulators/demodulators 332, detected by a base station MIMO detector 336 if applicable, and further processed by a base station reception processor 338 to obtain decoded data and control information sent by the UE 315. The base station reception processor 338 may provide the decoded data to a base station data sink 346 and the decoded control information to the base station controller/processor 340.

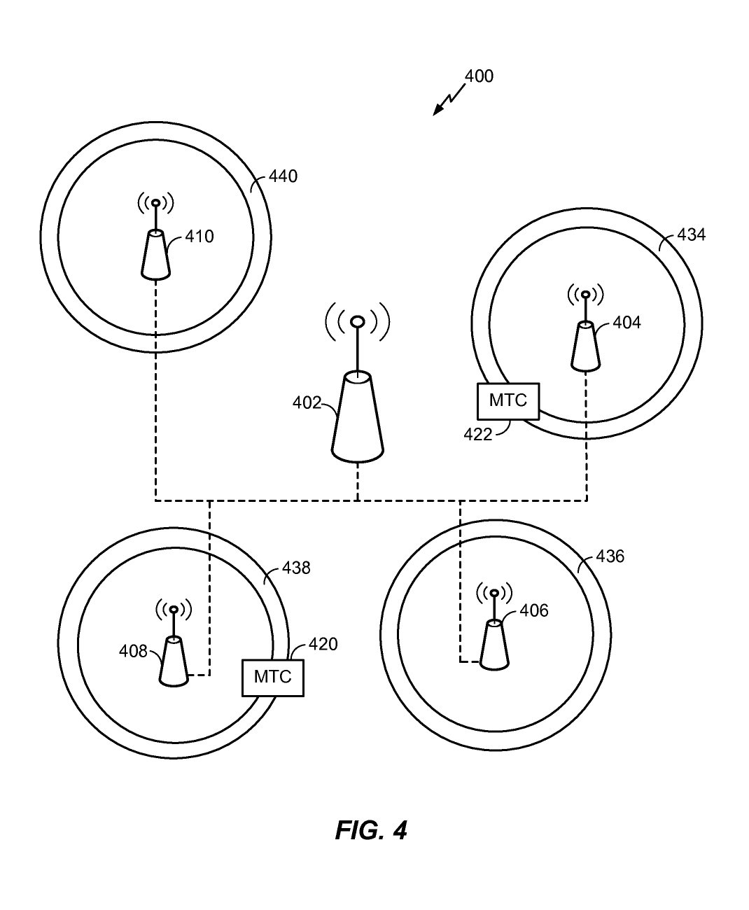

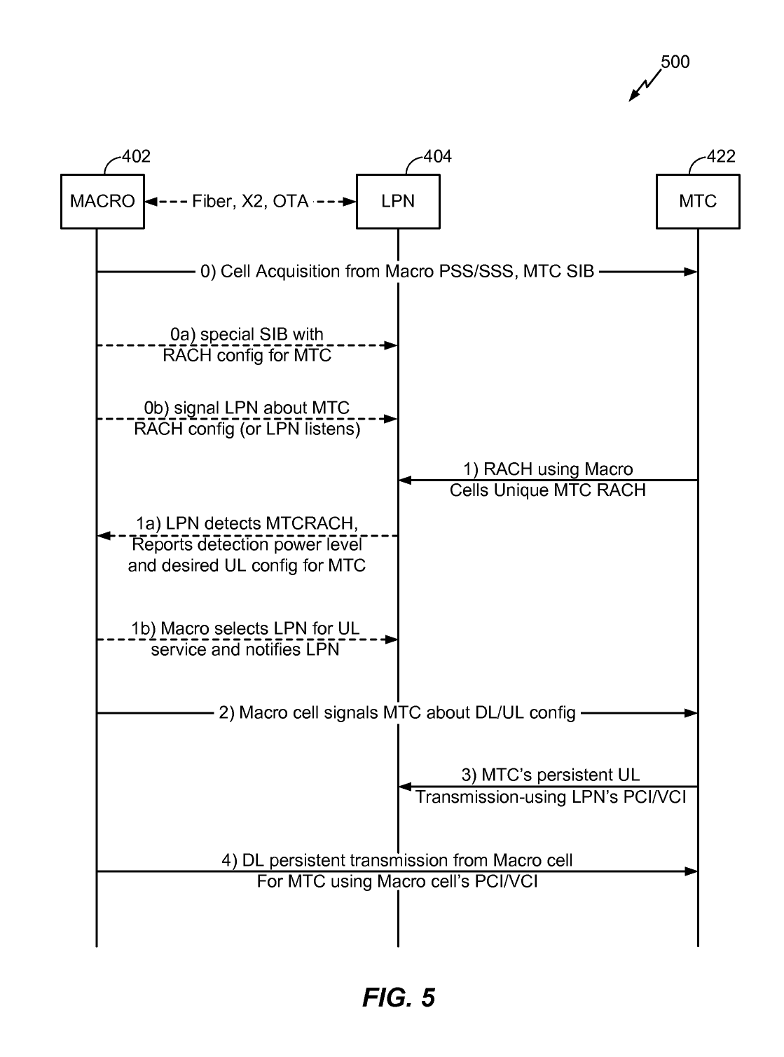

The base station controller/processor 340 and the UE controller/processor 380 may direct the operation at the base station 310 and the UE 315, respectively. The base station controller/processor 340 and/or other processors and modules at the base station 310 may perform or direct, e.g., the execution of various processes for the techniques described herein. The UE controller/processor 380 and/or other processors and modules at the UE 315 may also perform or direct, e.g., the execution of the functional blocks illustrated in FIGS. 4 and 5, and/or other processes for the techniques described herein. The base station memory 342 and the UE memory 382 may store data and program codes for the base station 310 and the UE 315, respectively. A scheduler 344 may schedule UEs 315 for data transmission on the downlink and/or uplink.

FIG. 4 is a block diagram conceptually illustrating an example of a heterogeneous wireless communications system 400, in accordance with an aspect of the present disclosure. In the illustrated example, a macro eNodeB 402 may be coupled to low power nodes (LPNs) 404, 406, 408, and 410, for example, via an interface (e.g., an X2 interface with optical fiber). As noted above, LPNs 404-410 may have lower transmit power relative to the macro eNodeB 402 and may be, for example, a pico base station, relays, or remote radio heads (RRHs). As such, the macro eNodeB 402 may have a coverage area that encompasses (or at least overlaps with) coverage areas of LPNs 404-410. The LPNs 404-410 and macro eNodeB 402 may be implemented, for example, using various components as shown for base station 310 shown in FIG. 3. Similarly, MTC devices 420 and 422 may be implemented, for example, using various components as shown for UE 320 shown in FIG. 3.

According to certain aspects, the LPNs 404-410 may be configured with the same cell identifier (ID) as the macro eNode 402 or with different cell IDs. If the LPNs 404-410 are configured with the same cell ID, the macro eNodeB 402 and the LPNs 404-410 may operate as essentially one cell controlled by the macro eNodeB 402. On the other hand, if the LPNs 404-410 and the macro eNodeB 402 are configured with different cell IDs, the macro eNodeB 402 and the LPNs 404-410 may appear to a UE as different cells, though all control and scheduling may still remain with the macro eNodeB 402.

### Example Decoupled Downlink and Uplink Operation for Long Term Evolution

There are various locations within the heterogeneous wireless communications system 400 in which UL and DL communications decoupling may occur. For example, each LPN (404, 406, 408, and 410) may have a corresponding region (434, 436, 438, 440) referred to as an UL service zone in which an MTC device (420, 422) may receive DL communications from the macro eNodeB 402 and transmit UL communications to an LPN 404-410. For example, within UL service zone 438, MTC device 420 may receive DL service from macro eNodeB 402 and UL service from LPN 408. Similarly, within UL service zone 434, MTC device 422 may receive DL service from macro eNodeB 402 and UL service from LPN 404.

In some cases, however, if the MTC device moves closer to an LPN (than the inner boundary of an UL service zone), then the MTC device may also receive DL service from the LPN rather than the macro eNodeB 402. In other words, within this area, the MTC may receive both UL and DL service from the LPN.

MTC devices may perform cell acquisition by searching for DL transmissions from cells with a best signal strength. From the signal with the best signal strength, the MTC devices may obtain a physical cell identifier (PCI) and maintain a time tracking loop (TTL) and frequency tracking loop (FTL). As will be described herein, an MTC device may, in effect, perform cell acquisition separately for DL and UL services. To this end, an MTC device may perform a separate random access channel (RACH) procedure (e.g., with a LPN cell identified as noted above based on signal strength).

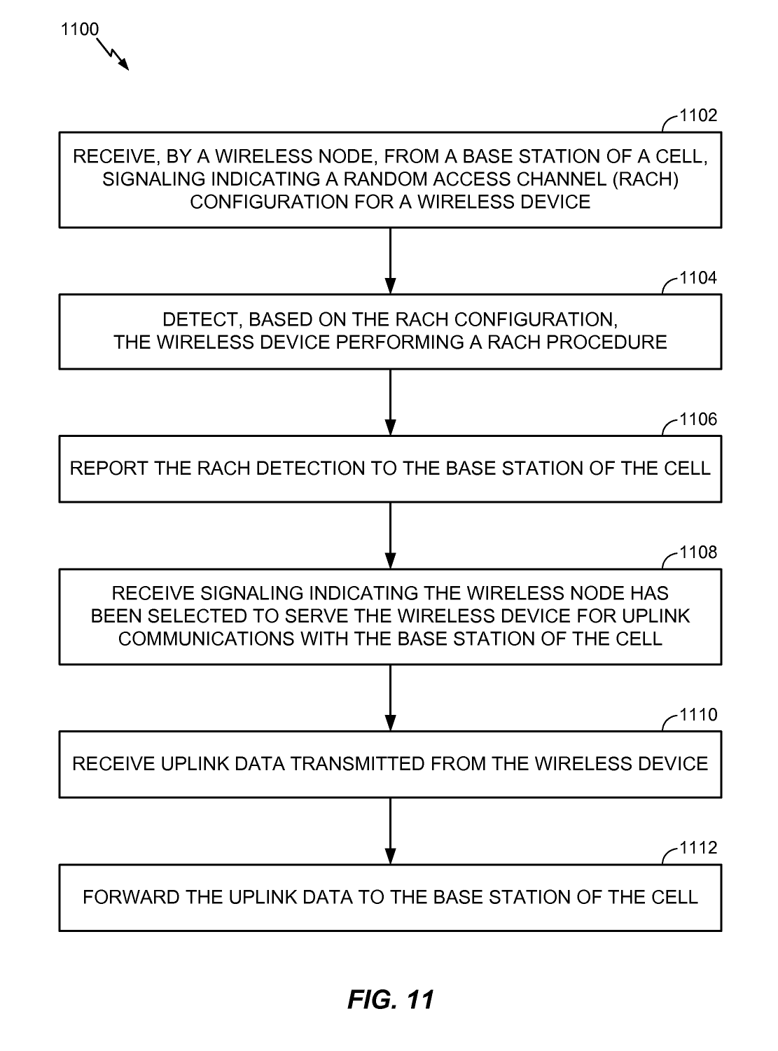

In some cases, a configuration for a RACH procedure by an MTC device may be carried in a system information block (SIB) targeting MTC devices—and this information may be shared with LPNs, allowing them to perform RACH detection. In some cases, this RACH configuration may be linked to the Macro cell ID and may include RACH sequence, timing, and power information. In some cases, the RACH configuration may also include timing for RACH messages (such as a MSG2 RACH response and/or MSG3 RRC connection request messages shown in FIG. 11), as well as modulation and coding scheme (MCS) and resource block (RB) assignment information. In some cases, such information may be shared with multiple LPNs within a macro eNodeB coverage area, allowing them to perform RACH detection for an MTC device. In an example, a plurality of LPNs within a macro eNodeB coverage area may detect a RACH message from an MTC device. As described below, the plurality of LPNs may send measurement reports for MTC RACH detection (e.g., indicating a receive signal strength or signal to noise ratio), allowing a macro eNodeB to select one (or more) of the plurality of LPNs for providing UL service (e.g., the LPN with the strongest reported signal strength for MTC RACH detection) for the MTC device.

FIG. 5 illustrates an exemplary call flow diagram 500 for an exchange of transmissions for a RACH procedure involving MTC device 422, macro eNodeB 402, and LPN 404 of FIG. 4. While a single LPN 404 is shown, it should be understood that several LPNs (in a dense deployment) may be independently performing similar operations to those described herein (e.g., and each reporting RACH detection).

As illustrated at step 0a), macro eNodeB 402 may configure MTC device 422 with a RACH configuration (e.g., via a special MTC SIB transmission). At step 0, the MTC device 422 performs cell acquisition, for example, based on macro PSS/SSS signals and/or the MTC SIB transmission. For example, MTC device 422 may receive PSS/SSS signals and/or an MTC SIB transmission broadcasted by the macro eNodeB 402 and the MTC device 422 may perform cell acquisition. As illustrated, at step 0b), the macro eNodeB 402 may also signal the MTC RACH configuration to LPNs 404 (e.g., via fiber, X2 or OTA). As an alternative, LPN 404 may acquire this information by listening (e.g., detecting the MTC SIB transmission).

In any case, having obtained the MTC RACH information (e.g., a unique MTC RACH preamble and timing of MTC RACH occasion), LPNs 404 may be able to detect an MTC RACH procedure (e.g., associated with a macro eNodeB 402) from the MTC device 422 and report the corresponding power measurement and/or a desired UL configuration to the macro eNodeB 402. In this way, the macro eNodeB 402 may select one or more of the best LPNs for providing UL (and/or DL) service to MTC device 422.

At step 1, MTC device 422 performs a RACH procedure (e.g., using the MTC RACH information having a macro eNodeB ID provided by macro eNodeB 402). Additional detail of the RACH procedure, according to one embodiment, is described below with reference to FIG. 11. Having obtained the MTC RACH information, one or more LPNs 404 is able to detect the MTC RACH, at 1a, and report the detected power level to macro eNodeB 402. As illustrated, the one or more LPNs 404 may also send desired UL configurations for serving the MTC device 422.

In the illustrated example, at step 1b) macro eNodeB 402 selects one or more LPNs 404 for providing UL service to MTC device 422, based on the reported RACH detection. In some embodiments, LPNs may indicate a signal strength of the RACH detection indicated in the report. In some embodiments, LPN 404 may only report when a RACH transmission has been detected above a threshold strength (e.g., receive strength or SNR), such that the report itself indicates the RACH transmission was detected with at least that threshold strength (which may be signaled to the LPN 404 by the macro eNode B 402). In any case, the macro eNodeB may notify one or more LPNs 404 of its selection. The macro eNodeB 402 may also signal information to the one or more LPNs 404, for example, indicating parameters for use in serving MTC device 422 on the UL and/or DL (e.g., an UL and/or DL configuration). In some cases, if joint UL reception is desired, the macro eNodeB 402 may inform a plurality of LPNs 404 of the joint processing configuration in order to serve the MTC device 422. Similarly, if joint DL transmission is desired, the macro eNodeB 402 may also inform a plurality of LPNs 404 that they have been selected for DL service to the MTC device 422.

At step 2, the macro eNodeB 402 signals MTC device 422 about its UL and DL configurations, allowing the MTC device 422 to receive DL transmissions from macro eNodeB 402 and to perform UL transmissions (e.g., via LPN 404). This information may be provided, for example, in a MSG2 (random access response). The UL and DL configuration information may include time for DL and UL transmission, power for UL transmission, physical cell identifier (PCI) or virtual cell identifier (VCI) for DL and UL transmissions, physical downlink shared channel (PDSCH) and/or physical uplink shared channel (PUSCH) assignment (e.g., for contention resolution), persistent assignment for data transmission (e.g., RB and/or MCS).

Having successfully decoupled uplink and downlink communications, at step 3, MTC device 422 may send UL transmissions (using the configuration information received at step 2, for example, the LPN's 404 physical cell identifier (PCI) or virtual cell identifier (VCI)) to LPN 404 and, in some cases, receive DL transmission from macro eNodeB 402, at step 4. In other words, the LPN 404 may also serve DL transmissions for the MTC device 422 when the LPN 404 is selected by the macro eNodeB 402 to serve the DL transmissions.

In some cases, certain routine procedures may be adjusted to account for the decoupling of UL and DL service, for example, to provide MTC devices with control information for UL transmissions (to an LPN) via a macro eNodeB (since it still provides DL service). For example, with regards to time tracking, a timing advance (TA) command may also be sent from a macro eNodeB, to be applied by an MTC device when transmitting on the uplink to an LPN. For frequency tracking, the LPN may maintain a FTL for UL frequency compensation or the macro eNodeB may signal the MTC a frequency offset to apply for UL transmission. Such timing advance and/or frequency offset adjustments may be applied, for example, by MTC device 422 when sending UL transmission in step 3 of FIG. 5. In some cases, such tracking may not be needed, for example, if LPNs and macro eNodeBs are synchronized (or frequency offset is small and can be handled by FTL at LPN). Regarding power control, an initial transmit power setting for UL data may decided by the LPN, but this setting may be transmitted from a macro eNodeB to the MTC device. Subsequent slow power control adjustment may also be signaled from the macro eNodeB to the MTC (e.g., on behalf of the LPN).

With regards to MTC initiated DL traffic, even if the traffic is on the downlink, the MTC device may still initiate the RACH procedure first, for example, to pull the data instead of having the network push the data. In this case, the techniques described above may still be used to decouple UL and DL operations. For network initiated DL traffic, the network may need to page the MTC. Pages may be sent in a paging area periodically monitored by MTC devices (e.g., from the strongest DL cell). The paging configuration for MTC can be signaled in SIB or configured to each device. In any case, if an MTC device detects paging, it may initiate a RACH procedure and, again, the techniques described above may still be used to decouple UL and DL operations.

According to certain aspects, a macro eNodeB may handle all the core network side of communications, which may work since, from the perspective of the MTC device, the macro eNodeB cell may still be considered the serving cell. As an alternative, however, the LPN may handle some or all core network side of communications.

While the techniques are described herein with reference to a UE capable of communicating in LTE and 3G networks (GSM and/or UMTS), the techniques presented herein may be applied in a variety of different RAT networks.

### Example Interface Between Low Power Node (LPN) and Macro Cell to Enable Decoupled Uplink (UL) and Downlink (DL) Communication

As mentioned above, one way to provide effective coverage for machine type communications (MTC) devices (e.g., MTCs 420, 422), which may be located in areas with large penetration loss, is to deploy low power nodes (LPNs) (e.g., LPNs 404-410) within the Macro base station (BS) coverage area (e.g., Macro 402) to reduce the path loss to the closest node with cell splitting. However, also as mentioned above, uplink (UL)/downlink (DL) decoupling may be desirable because the best DL is not always the best UL due to the large transmit power difference from Macro BS to LPN. Example decoupled operations for user equipment (UE), LPN, and Macro BS are described above. Decoupled UL/DL operations may be enabled by exploiting specific features of MTC traffic such as, for example, the low latency requirement and the low spectral efficiency requirement.

Techniques and apparatus are provided herein for an interface between the Macro cell and LPN to enable control plane signaling and UL data forwarding.

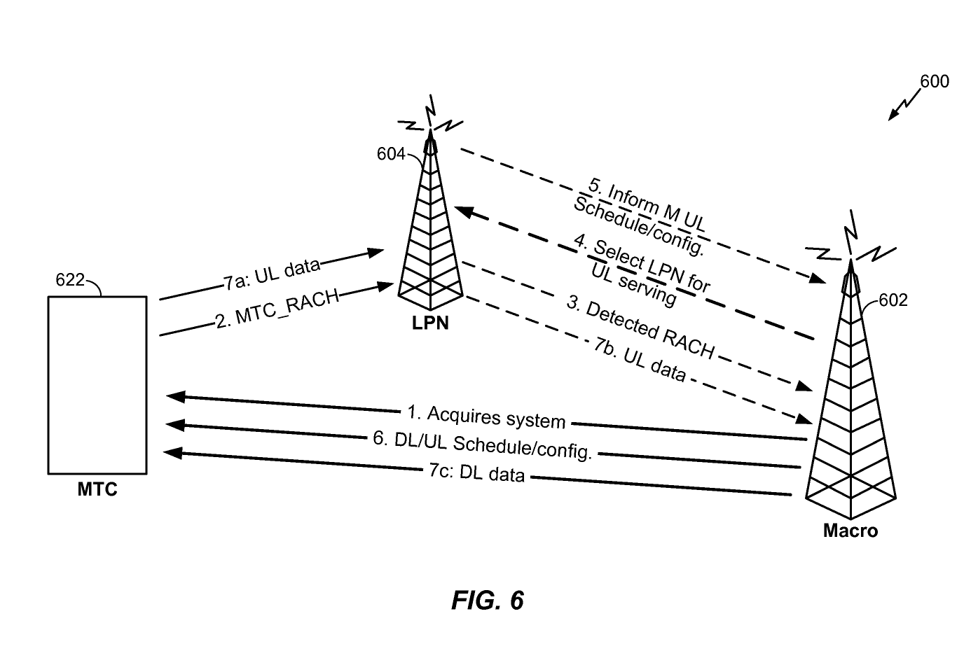

FIG. 6 illustrates example architecture and call flow 600 for decoupled DL/UL operation, in accordance with certain aspects of the present disclosure. As shown in FIG. 6, all DL signaling to the MTC device 622 may be transmitted to the MTC device 622 from the Macro cell 602. For MTC traffic, random access channel (RACH) and automatic repeat request (ARQ) timing may be relaxed. By exploiting delay tolerance of the MTC traffic and by utilizing new message exchanges between the LPN 604 and Macro BS 602 may enable decoupled DL/UL operation.

According to certain aspects, UE UL forward activation may be initiated by the LPN 604. As seen in FIG. 6, at 1, the Macro cell 602 may send system information to the MTC device 622. At 2, The MTC device 622 may then signal MTC_RACH to the LPN 604. The LPN 604 may detect the MTC_RACH and, at 3, inform the Macro cell 602 that RACH was detected by sending a RACH Detection message with RACH information (e.g., timing advance (TA), signal-to-noise ratio (SNR), and/or power). At 4, the Macro cell 602 may select the LPN 604 to serve the UL—the selection result may be positive or negative. At 5, the LPN 604 may inform the Macro cell 602 of UL scheduling and configuration (e.g., resource block (RB), modulation and coding scheme (MCS), TA, power control, etc.) and, at 6, the Macro cell 602 may then signal DL/UL scheduling and configuration to the MTC device 622. At 7a, the MTC device 622 may signal UL data which, at 7b, the LPN 604 may intercept and forward to the Macro cell 602. At 7c, the Macro cell 602 may send DL data to the MTC device 622.

According to certain aspects, for LPN-assisted RACH, Macro cell 602 signal to the LPN 604 indicating the LPN selection for UL serving (at 4) and the LPN 604 signal to the Macro cell 602 informing the Macro cell 602 of UL scheduling and configuration (at 5) may be exchanged before the Macro cell 602 acts on the RACH message from the MTC device 622 (e.g., the UE).

Alternatively, the Macro cell 602 may receive RACH directly from the MTC device 622 and proceed with UL/DL scheduling configuration (in other words, skipping steps 2-5 in the above procedure). In aspects, the Macro cell 602 may then use RACH detection from the LPN 604 to determine whether to use the LPN 604 for the MTC device 622 and then proceed with the LPN selection for serving on UL signaling (e.g., step 2).

In aspects, the UE UL data transfer from the MTC device 622 to the LPN 604, at 7a, may consist of a medium access control (MAC) protocol data unit (MPDU). In aspects, the LPN 604 may also forward UL scheduling information to the Macro cell 602 if needed.

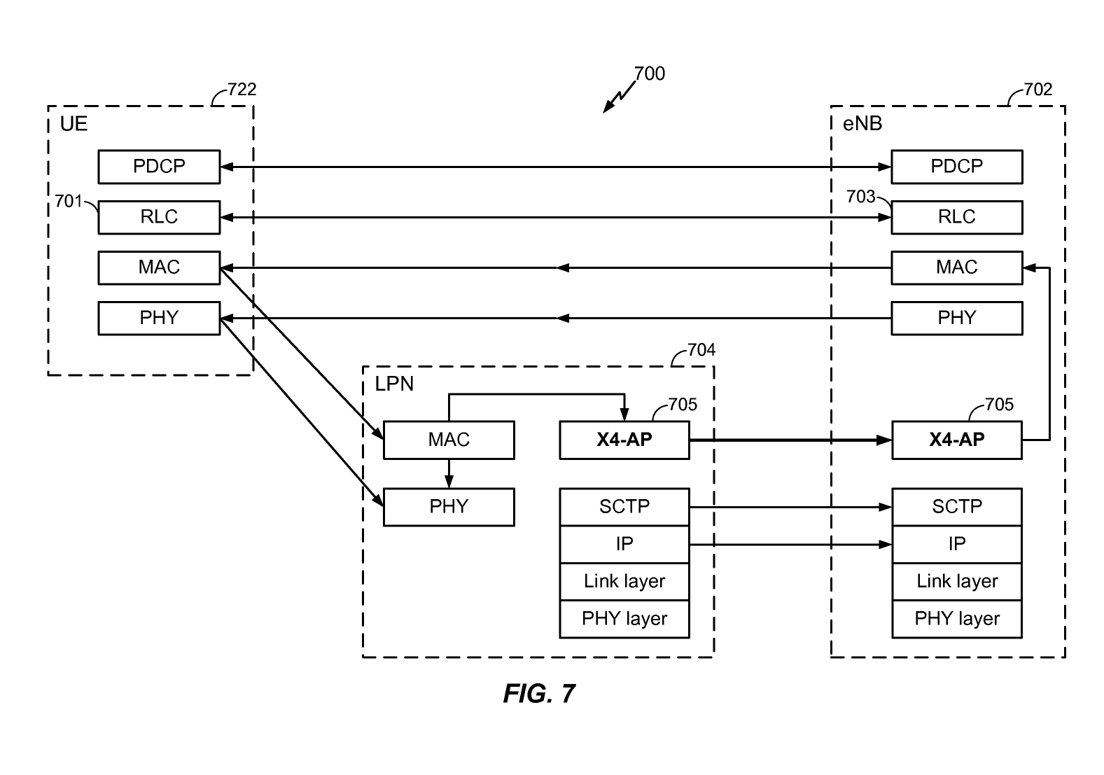

FIG. 7 illustrates example user plane protocol stacks 700 for UE 722 (e.g., similar to MTC device 622), eNB 702 (e.g., similar to Macro cell 602), and LPN 704 (e.g., similar to LPN 604), in accordance with certain aspects of the present disclosure. As shown in FIG. 7, a single radio link control (RLC) 703 may be located at the Macro cell 702 and a single RLC 701 may be located at the UE 722. As mentioned above, the LPN 704 may forward UL data from the UE 722 to the Macro cell 702 via tunneling between the LPN 704 and eNB 702 via an X4-AP interface 705. The X4 interface may a new interface which may have the same protocol stack as X2 or may be an extension of the X2 interface in the MAC and physical (PHY) layers.

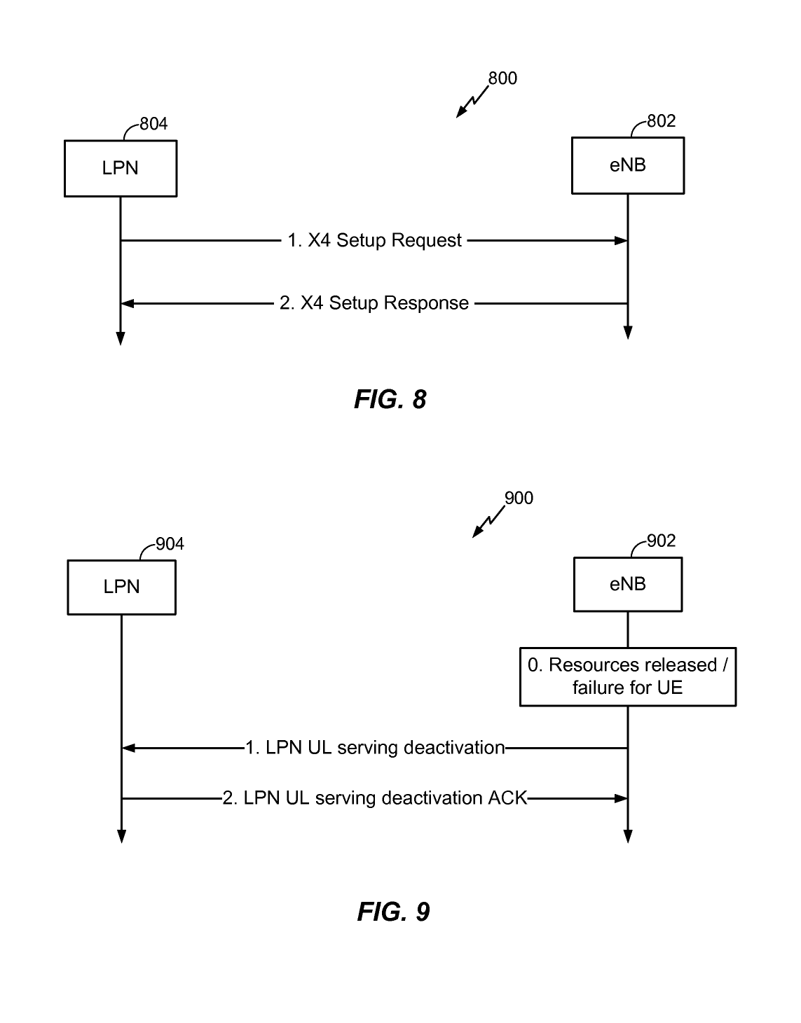

FIG. 8 illustrates an example call flow for X4 interface setup procedure 800 between an LPN 802 and eNB 802 (e.g., a Macro cell), in accordance with certain aspects of the present disclosure. As shown in FIG. 8, at 1, the LPN 904 may signal an X4 Setup Request message to the eNB 802. At 2, the eNB 802 may then signal an X4 Setup Response message to the LPN 804. While the example illustrated in FIG. 8 is for LPN-initiated X4 Setup procedure, in aspects, the procedure may instead be eNB initiated.

According to certain aspects, the eNB 802 may send the LPN 804 a eNB Configuration Update message which may include the list of cells served in order to delete, add, or modify a served cell information ID or PRACH configuration (e.g., sequence, time/frequency location, etc.). In response to the eNB Configuration Update message, the LPN 804 may signal an eNB Configuration Update Acknowledgement (ACK) message to the eNB 802. According to certain aspects, the LPN 604 may signal an LPN Configuration Update to the eNB 802 which may include UL configuration information (e.g., virtual cell ID, UL channel configuration, etc.).

FIG. 9 illustrates an example call flow 900 for UE UL forwarding deactivation between an LPN 904 and eNB 902 (e.g., a Macro cell), in accordance with certain aspects of the present disclosure. As shown in FIG. 9, the UE UL forwarding deactivation may be initiated, at 0, by the eNB 902, for example, when the remote radio connection (RRC) is released, when the RRC connection establishment fails, or when the eNB 902 declares radio link failure (RLF). At 1, the eNB 902 may send a LPN UL serving deactivation message to the LPN 904. In response, at 2, the LPN 904 may send a LPN UL serving deactivation ACK message to the eNB 902. Alternatively, in aspects, the UE UL forwarding deactivation may be LPN-initiated, for example, for LPN power savings.

According to certain aspects, UL timing and power, which may be measured on RACH and other UL signals from the LPN, may be signaled to the Macro cell for TA and power control.

According to certain aspects, for pre-scheduled transmission, MCS and RB information may be sent from the LPN to the Macro cell via the X4 interface, and then assignments may be sent by the Macro BS to the UE on the DL. In aspects, physical uplink shared channel (PUSCH) data, power headroom report (PHR), buffer status report (BSR), and channel state information (CSI) may also be sent by the LPN to the Macro cell by X4. The LPN may decode the PUSCH/PHR/BSR/CSI and forward to the Macro cell. In aspects, the LPN may also inform the Macro cell of UL scheduling information based on BSR and loading.

According to certain aspects, the Macro cell may send a supervision request on the DL informing the LPN serving the UL of the supervision response via the X4 connection. The LPN may receive the supervision response and respond to the Macro BS via the X4.

According to certain aspects, the Macro cell may decide when to release the RRC connection and inform the LPN via the X4.

According to certain aspects, no new decoupled operation may be triggered where there is a different RACH configuration from the initial RACH. Persistent scheduling may be tied to supervision. A discovery signal may be tied to connectionless data transmission.

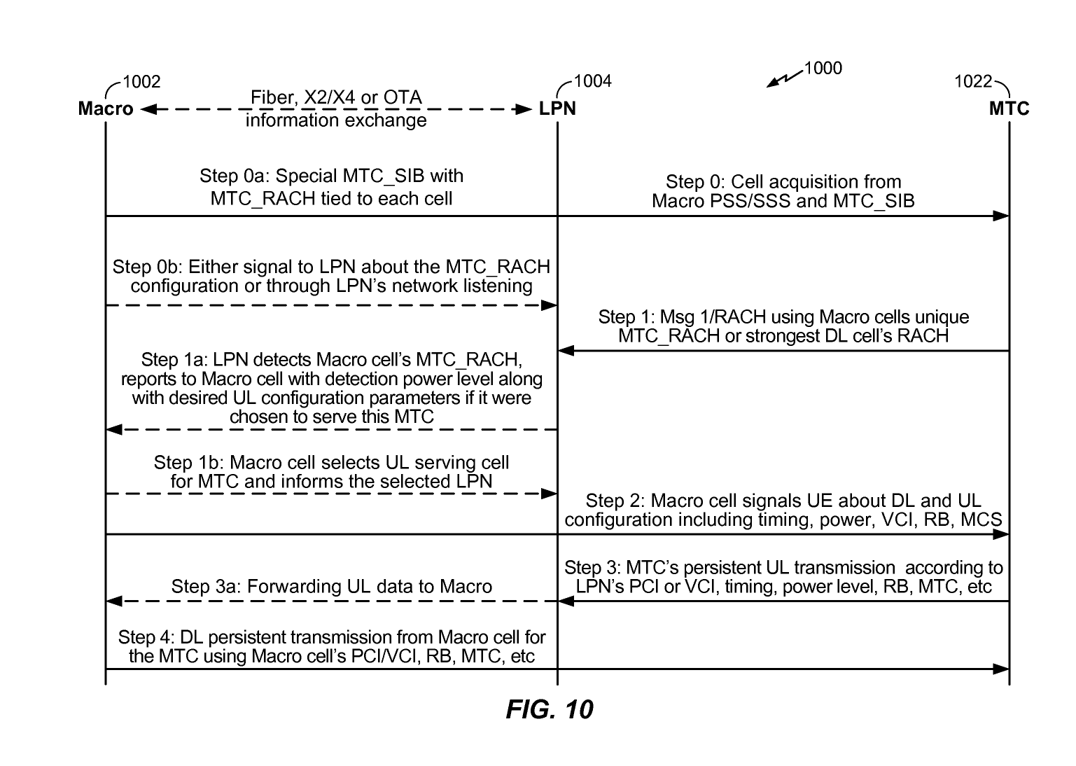

FIG. 10 illustrates an example call flow 1000 for decoupled DL/UL operation, in accordance with certain aspects of the present disclosure. As shown in FIG. 10, the Macro cell 1002 and LPN 1004 may communicate via a fiber, x2 or x4 interface, or over-the-air (OTA) information exchange. At Step 0a, the Macro cell 1002 may send a special MTC_SIB, with MTC_RACH tied to each cell, to the MTC device 1022. At Step 0, the MTC device 1022 may perform cell acquisition from Macro primary synchronization signal (PSS), secondary synchronization signal (SSS), and the MTC SIB received from the Macro cell 1002. At Step 0b, the Macro cell 1002 may either signal MTC_RACH configuration to the LPN 1004 or the LPN 1004 may obtain the MTC_RACH configuration through network listening. At step 1, the MTC device 1022 may send RACH message 1 to the LPN 1004 using the Macro cells unique MTC_RACH or the strongest DL cell's RACH. At Step 1a, the LPN 1004 may detect the Macro cell's MTC_RACH and report the detection to the Macro cell 1002 along with desired UL configuration parameters if the LPN 1004 were chosen to serve the MTC device 1022. At Step 1b, the Macro cell 1002 may select UL serving cell for the MTC device 1022 and inform the selected LPN (e.g., LPN 1004). At Step 2, the Macro cell 1002 may signal the MTC device 1022 about DL and UL configuration including timing, power, VCI, RB, MCS, etc. At Step 3, the MTC device 1022 may send persistent UL transmission to the LPN 1004 according to the LPN's PCI or VCI, timing, power level, RB, MTC, etc. At Step 3a, the LPN 1004 may forward UL data to the Macro cell 1002. At Step 4, the Macro cell 1002 may send persistent transmission to the MTC device 1022 using the Macro cell's PCI/VCI, RB, MTC, etc.

FIG. 11 illustrates example operations 1100 for wireless communications, in accordance with certain aspects of the present disclosure. The operations 1100 may be performed, for example, by a wireless node (e.g., LPN). The operations 1100 may begin, at 1102, by receiving, from a BS of a cell (e.g., Macro cell), signaling indicating a RACH configuration for a wireless device. According to certain aspects, the signaling indicating the RACH configuration of the wireless device may be received via an X2, X4, backhaul, or over the air (OTA) interface. For example, the wireless node may establish an X2, X4, backhaul, or OTA interface with the BS of the cell and receive an indication of the RACH configuration during the establishment of the interface. The wireless node may transmit uplink configuration information to the base station of the cell as part of the establishment.

At 1104, the wireless node may detect, based on the RACH configuration, the wireless device (e.g., MTC device or UE) performing a RACH procedure.

At 1106, the wireless node may report the RACH detection to the BS of the cell. For example, the wireless node may report a power level or a timing advance of the RACH detection. According to certain aspects, after detecting the wireless device performing a RACH procedure, the wireless node may transmit a RACH response to the wireless device and may receive a connection request message from the wireless device.

At 1108, the wireless node may receive signaling indicating the wireless node has been selected to serve the wireless device for UL communications with the BS of the cell.

At 1110, the wireless node may receive UL data transmitted from the wireless device. According to certain aspects, the wireless node may receive pre-scheduled UL transmissions from the wireless device (e.g., semi-persistently scheduled UL transmissions).

At 1112, the wireless node may forward the UL data to the BS station of the cell. According to certain aspects, the wireless node may receive a MPDU and forward the received MPDU to the BS in a single message.

According to certain aspects, the wireless node may forward UL scheduling information to the BS of the cell based on loading or a buffer status register (BSR) of the wireless device.

According to certain aspects, the wireless node may also perform a deactivation procedure to stop serving the wireless device for UL transmissions. In aspects, the apparatus may initiate the deactivation procedure. Alternatively, the BS of the cell may initiate the deactivation procedure.

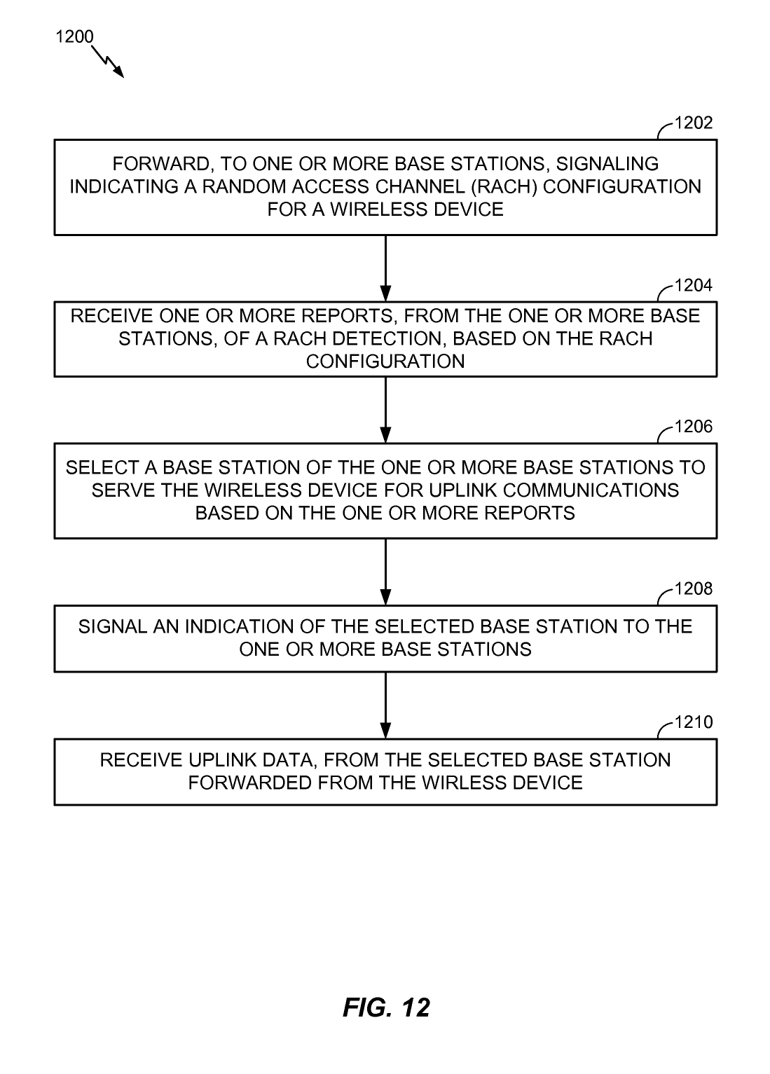

FIG. 12 illustrates example operations 1200 for wireless communications, in accordance with certain aspects of the present disclosure. The operations 1200 may be performed, for example, by a wireless node (e.g., Macro). The operations 1200 may begin, at 1202, by forwarding, to one or more base stations, signaling (e.g., via an X2, X4, backhaul, or OTA interface) indicating a random access channel (RACH) configuration for a wireless device. For example, the wireless node may establish an X2, X4, backhaul, or OTA interface with the one or more base stations and forward the indication of the RACH configuration during the establishment. In aspects, uplink configuration information may be received from the one or more base stations as part of the establishment of the interface.

At 1204, the wireless node may receive one or more reports, from the one or more base stations, of a RACH detection based on the RACH configuration. For example, the wireless node may receive a power level or a timing advance of the RACH detection.

At 1206, the wireless node may select a base station of the one or more base stations to serve the wireless device for uplink communications based on the one or more reports;

At 1208, the wireless node may signal an indication of the selected base station to the one or more base stations.

At 1210, the wireless node may receive uplink data (e.g., based on loading or a BSR of the wireless device), from the selected base station forwarded from the wireless device. For example, the wireless node may receive an A-MPDU from the selected base station in a single message.

As used herein, a phrase referring to “at least one of” a list of items refers to any combination of those items, including single members. As an example, “at least one of: a, b, or c” is intended to cover: a, b, c, a-b, a-c, b-c, and a-b-c.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications by a wireless node, comprising:
receiving, from a base station of a cell, signaling indicating a random access channel (RACH) configuration for a wireless device;
detecting, based on the RACH configuration, the wireless device performing a RACH procedure;
reporting the RACH detection to the base station of the cell;
receiving signaling indicating the wireless node has been selected to serve the wireless device for uplink communications with the base station of the cell;
receiving uplink data transmitted from the wireless device; and
forwarding the uplink data to the base station of the cell.

2. The method of claim 1, wherein the signaling indicating the RACH configuration of the wireless device is received via a backhaul interface.

3. The method of claim 2, further comprising:
establishing the backhaul interface with the base station of the cell; and
receiving an indication of the RACH configuration during the establishment.

4. The method of claim 3, further comprising transmitting uplink configuration information to the base station of the cell as part of the establishment.

5. The method of claim 1, further comprising, after detecting the wireless device performing a RACH procedure,
transmitting a RACH response to the wireless device; and
receiving a connection request message from the wireless device.

6. The method of claim 1, wherein:
the uplink data is received as a medium access control (MAC) protocol data unit (MPDU); and
forwarding the uplink data to the base station of the cell comprises transmitting the received MPDU to the base station in a single message.

7. The method of claim 6, further comprising forwarding uplink scheduling information to the base station of the cell based on at least one of loading or a buffer status register (BSR) of the wireless device.

8. The method of claim 1, further comprising performing a deactivation procedure to stop serving the wireless device for uplink transmissions.

9. The method of claim 8, further comprising initiating the deactivation procedure.

10. The method of claim 1, wherein receiving uplink data transmitted from the wireless device comprises receiving pre-scheduled uplink transmissions from the wireless device.

11. The method of claim 10, wherein the pre-scheduled uplink transmissions comprise semi-persistently scheduled uplink transmissions.

12. The method of claim 1, wherein reporting the RACH detection comprises at least one of reporting a power level or a timing advance of the RACH detection.

13. A method for wireless communications by a wireless node, comprising:
forwarding, to one or more base stations, signaling indicating a random access channel (RACH) configuration for a wireless device;
receiving one or more reports, from the one or more base stations, of a RACH detection based on the RACH configuration;
selecting a base station of the one or more base stations to serve the wireless device for uplink communications based on the one or more reports;
signaling an indication of the selected base station to the one or more base stations; and
receiving uplink data, from the selected base station forwarded from the wireless device.

14. The method of claim 13, wherein the signaling indicating the RACH configuration of the wireless device is forwarded via a backhaul interface.

15. The method of claim 14, further comprising:
establishing the backhaul interface with the one or more base stations; and
forwarding an indication of the RACH configuration during the establishment.

16. The method of claim 15, further comprising receiving uplink configuration information from the one or more base stations as part of the establishment.

17. The method of claim 13, wherein receiving the forwarded uplink data comprises receiving a medium access control (MAC) protocol data unit (MPDU) from the selected base station in a single message.

18. The method of claim 17, further comprising receiving uplink scheduling information from the selected base station based on at least one of loading or a buffer status register (BSR) of the wireless device.

19. The method of claim 13, wherein receiving the one or more reports of a RACH detection comprises at least one of receiving a power level or a timing advance of the RACH detection.

20. An apparatus for wireless communications by a wireless node, comprising:
means for receiving, from a base station of a cell, signaling indicating a random access channel (RACH) configuration for a wireless device;
means for detecting, based on the RACH configuration, the wireless device performing a RACH procedure;
means for reporting the RACH detection to the base station of the cell;
means for receiving signaling indicating the wireless node has been selected to serve the wireless device for uplink communications with the base station of the cell;
means for receiving uplink data transmitted from the wireless device; and
means for forwarding the uplink data to the base station of the cell.

21. The apparatus of claim 20, wherein the signaling indicating the RACH configuration of the wireless device is received via a backhaul interface.

22. The apparatus of claim 20, further comprising, after detecting the wireless device performing a RACH procedure,
means for transmitting a RACH response to the wireless device; and
means for receiving a connection request message from the wireless device.

23. The apparatus of claim 20, wherein:
the uplink data is received as a medium access control (MAC) protocol data unit (MPDU); and
forwarding the uplink data to the base station of the cell comprises transmitting the received MPDU to the base station in a single message.

24. The apparatus of claim 20, further comprising means for performing a deactivation procedure to stop serving the wireless device for uplink transmissions.

25. The apparatus of claim 20, wherein reporting the RACH detection comprises at least one reporting a power level or a timing advance of the RACH detection.

26. An apparatus for wireless communications by a wireless node, comprising:
means for forwarding, to one or more base stations, signaling indicating a random access channel (RACH) configuration for a wireless device;
means for receiving one or more reports, from the one or more base stations, of a RACH detection based on the RACH configuration;
means for selecting a base station of the one or more base stations to serve the wireless device for uplink communications based on the one or more reports;
means for signaling an indication of the selected base station to the one or more base stations; and
means for receiving uplink data, from the selected base station forwarded from the wireless device.

27. The apparatus of claim 26, wherein the signaling indicating the RACH configuration of the wireless device is forwarded via a backhaul interface.

28. The apparatus of claim 27, further comprising:
means for establishing the backhaul interface with the one or more base stations; and
means for forwarding an indication of the RACH configuration during the establishment.

29. The apparatus of claim 28, further comprising means for receiving uplink configuration information from the one or more base stations as part of the establishment.

30. The apparatus of claim 26, wherein receiving the forwarded uplink data comprises receiving a medium access control (MAC) protocol data unit (MPDU) from the selected base station in a single message.
